(19) United States
(12) Patent Application Publication
(10) Pub. No.: US 2010/0287335 A1
(43) Pub. Date: Nov. 11, 2010

(54) Read Enable Signal Adjusting Flash Memory Device and Read Control Method of Flash Memory Device

(76) Inventors: Hyunmo Chung, Gyeonggi-do (KR); Hanmook Park, Gyeonggi-do (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/810,984

(22) PCT Filed: Aug. 25, 2008
(86) PCT No.: PCT/KR08/04964

§ 371 Date: Jun. 28, 2010

(30) Foreign Application Priority Data
Dec. 27, 2007 (KR) 10-2007-0139106

(51) Int. Cl. G06F 12/02

(52) U.S. Cl. 711/103; 711/E12.008

(57) ABSTRACT

Disclosed is a flash memory device for adjusting a read signal timing and read control method of the flash memory device. The flash memory device includes a plurality of flash memory units, a common input/output bus connected with each of the plurality of flash memory units, and a controller to propagate the read control signal to a flash memory unit selected from among the plurality of flash memories and to receive data read from the selected flash memory unit via the common input/output bus, the controller being connected with the common input/output bus, wherein the controller adjusts a propagation timing of the read control signal unit based on a propagation delay corresponding to the selected flash memory unit, and thereby controlling a timing optimized for each flash memory unit.

### TECHNICAL FIELD

The present invention relates to a flash memory device, and particularly, to a controller that controls a read operation of the flash memory and a method thereof.

### BACKGROUND ART

A flash memory is a non-volatile memory device that is resistant to impact, operable with a low power, and has a high degree of integration. The flash memory is generally used as a storage medium for a portable terminal, an embedded system, and the like. Recently, as a price of the flash memory is reduced, a product in a Solid State Disk (SSD) type which increases a storage capacity through connecting a plurality of flash memories has been developed, and the SSD has been utilized in many fields as a substitute storage medium for a hard disk.

A flash memory available on the market has about 8 Gb to 64 Gb capacity, 200 us internal operation time, and 25 ns/byte data transmission rate. Accordingly, to use the flash memory as a mass storage device equivalent to the hard disk, enlarging a bandwidth and the capacity through connecting a plurality of flash memories is required.

A general SSD includes a plurality of flash memory units. The SSD is composed of a plurality of channels that independently operates. Also, a single channel is composed of a plurality of flash memory banks sharing a bus. A single bank is composed of at least one flash memory that shares an address bus and has a separate data bus.

A predetermined delay time Td after a negative READ ENABLE (nRE) signal of the single channel falls to 0, read data starts to be outputted to a bus from a chip-enabled memory bank and a predetermined delay time (Td) after the nRE signal rises to 1, the read data disappears from the bus. A computing system (a host system or processor) is required to read data using a buffer while read data is normally outputted to a bus. Here, a time from when the normal read data occupies the bus to when the computing system starts to read the data is referred to as a setup time. The setup time is required to be sufficient, specifically, the setup time is required to be as much as a time required from each flash memory in order for the computing system to normally read the read data from the bus.

The delay time Td may be different for each flash memory. A difference in Td may occur due to a characteristic variation of the flash memory device or a distance variation with the computing system, and the Td even in a single flash memory may vary according to an operational environment, such as temperature and the like.

When the delay time of the flash memory device is excessively long, the normally read data may not appear in the bus at the time the computing system is required to read the read data from the bus. In this instance, it is said that the flash memory device and the computing system fail to satisfy the setup time, and it is not reliable that a value that the computing system read is a value of the normally read data.

As the SSD becomes a mass storage medium, more flash memory devices are connected together and a case that a single controller or a single computing system controls the flash memory device has increased. Development of a method for controlling a timing to reduce a read error is required to keep pace with a trend of pursuing a high capacity and high-speed of a system clock.

### DISCLOSURE OF INVENTION

### Technical Goals

An aspect of the present invention provides a device and method for controlling a read timing optimized for each flash memory.

Another aspect of the present invention also provides a device and method for reducing an error of a read operation of a flash memory even when the flash memory performs with a clock of a high operation frequency.

Still another aspect of the present invention also provides a device and method for reducing an error of a read operation of a flash memory when many flash memories are connected together to obtain a high bandwidth.

### Technical Solutions

According to an aspect of the present invention, there is provided a flash memory device including a plurality of flash memory units, a common input/output bus connected with each of the plurality of flash memory units, and a controller to propagate a read control signal to a flash memory unit selected from among the plurality of flash memories and to receive data read from the selected flash memory unit via the common input/output bus, the controller being connected with the common input/output bus, wherein the controller adjusts a propagation timing of the read control signal unit based on a propagation delay corresponding to the selected flash memory unit.

According to another aspect of the present invention, there is also provided a flash memory device including a flash memory unit and a controller to propagate a read control signal to the flash memory unit and to receive data read from the flash memory unit via a data route, wherein the controller adjusts a propagation timing of the read control signal based on a propagation delay corresponding to the flash memory unit.

According to still another aspect of the present invention, there is also provided a flash memory device including a flash memory unit storing a test pattern and a controller to propagate a read control signal with respect to the test pattern to the flash memory unit and to receive the stored test pattern from the flash memory unit, wherein the controller detects whether an error exists in the received test pattern to search for an optimized read control timing and adjusts a propagation timing of the read control signal with respect to the flash memory unit based on the retrieved read control timing.

According to yet another aspect of the present invention, there is also provided a read control method of a flash memory device including propagating a read control signal with respect to a test pattern to a flash memory unit, receiving the test pattern from the flash memory unit, verifying whether an error exists in the received test pattern, and adjusting a propagation timing of the read control signal with respect to the test pattern according to a result of the verifying.

### ADVANTAGEOUS EFFECTS

According to an aspect of the present invention, there is provided a method for adjusting a read timing control optimized for each flash memory.

Also, according to the present invention, there is provided a method for reducing an error of a read operation of a flash memory even when the flash memory performs with a clock of a high operation frequency.

Also, according to the present invention, there is provided a method for reducing an error of a read operation of a flash memory even when many flash memories are connected together to obtain a high bandwidth.

### BRIEF DESCRIPTION OF DRAWINGS

FIG. 1 illustrates a flash memory device according to an example embodiment of the present invention;

FIG. 2 illustrates an example of a flash memory read control method performed by a flash memory device;

FIG. 3 illustrates another example of a flash memory read control method performed by a flash memory device;

FIG. 4 illustrates still another example of a flash memory read control method performed by a flash memory device; and

FIG. 5 is a flowchart illustrating a flash memory read control method according to example embodiment of the present invention.

### BEST MODE FOR CARRYING OUT THE INVENTION

Although a few example embodiments of the present invention will be shown and described, the present invention is not limited to the described example embodiments, wherein like reference numerals refer to the like elements throughout.

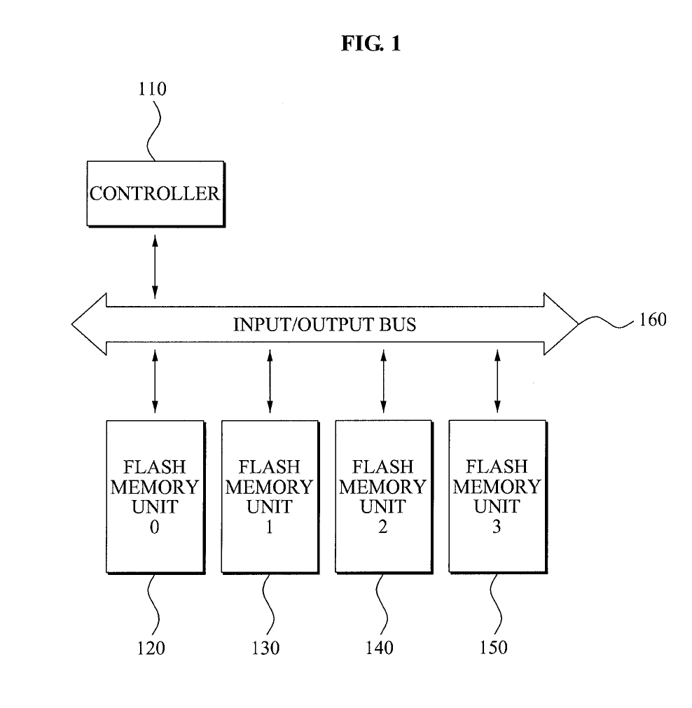

FIG. 1 illustrates a flash memory device 100 according to an example embodiment of the present invention.

Referring to FIG. 1, the flash memory device 100 includes a controller 110 and input/output bus 160. Also, the flash memory device 100 include a flash memory unit (0) 120, flash memory unit (1) 130, flash memory unit (2) 140, and flash memory unit (3) 150.

The input/output bus is respectively connected with the flash memory unit (0) 120, flash memory unit (1) 130, flash memory unit (2) 140, and flash memory unit (3) 150, and commonly propagates and receives data.

The controller 110 is connected with the common input/output bus 160, and the controller may be either a controller being inside an SSD, as an example embodiment, including the flash memory, or may be a computing system or host system being outside the SSD.

The input/output bus 160 may be a common data input/output bus corresponding to a single channel.

A propagation delay between the controller 110 and flash memory unit (0) 120 may be less than a propagation delay between the controller 110 and flash memory unit (1) 130. As a number of flash memory units to be connected with the input/output bus 160 increases, a variation of the delay time increases.

To eliminate a data propagation and reception error occurring due to a propagation delay between each of the flash memory units (0, 1, 2, and 3) 120, 130, 140, and 150 and the controller 110, the flash memory device 100 adjusts a timing of a read control signal nRE. The flash memory device 100 may compensate for a variation of the propagation delay through the adjusting the timing of the read control signal nRE.

The flash memory device 100 provides a propagation timing of nRE optimized for each of the flash memory units (0, 1, 2, and 3) 120, 130, 140, and 150, thereby being applicable to a high capacity flash memory system like the SSD. Since many flash memory units are used in the high capacity flash memory system, a variation of the propagation delay increases. Accordingly, increasing throughput of data in a conventional configuration is difficult due to the increased variation of the propagation delay.

The flash memory device 100 according to example embodiment may adjust a timing of the read control signal nRE with respect to each of the plurality of flash memory units (0, 1, 2, and 3) 120, 130, 140, and 150 in a real time, and thereby can propagate and receive data without an error even under a high system clock environment. Also, the flash memory device 100 may increase throughput of the data without an error even in a flash memory system including more flash memory units (not illustrated) than a number of memory units shown in FIG. 1.

The controller 110 propagates the read control signal nRE to a flash memory unit selected from among the flash memory units (0, 1, 2, and 3) 120, 130, 140, and 150. Here, for example, it is assumed that the flash memory unit (2) 140 is selected.

The selected flash memory unit (2) 140 propagates read data via a common input/output bus 160 a predetermined time after receiving the read control signal nRE. In this instance, the predetermined time from when receiving the read control signal nRE to when outputting data to the common input/output bus 160 may be a unique system delay time of the flash memory unit (2) 140 or an output enable time between the flash memory unit (2) 140 and the common input/output bus 160.

The selected flash memory unit (2) 140 may propagate the read data to the controller 110 via the common input/output bus 160 the predetermined time after receiving the read control signal nRE, besides the natural delay time.

The controller 110 receives the read data propagated from the selected flash memory unit (2) 140 via the common input/output bus 160.

The controller 110 adjusts a propagation timing of the read control signal nRE propagated to the selected flash memory unit (2) 140 based on a propagation delay between the selected flash memory unit (2) 140 and the controller 110. In this instance, the controller 110 also adjusts the propagation timing of the read control signal nRE based on a delay time between the selected flash memory unit (2) 140 and the common input/output bus 160.

The input/output bus 160 may be a common input/output bus corresponding to a single channel. Each of the flash memory units (0, 1, 2, and 3) 120, 130, 140, and 150 may be a bank respectively connected with the single channel. The controller 110 may respectively adjust a propagation timing of a read control signal with respect to each bank.

The controller 110 may respectively propagate a system clock signal to each of the flash memory units (0, 1, 2, and 3) 120, 130, 140, and 150. The system clock propagated by the controller 110 may be a synchronized signal through a phase locked loop (PLL) circuit, a delay locked loop (DLL) circuit, and the like. The controller 110 may adjust the propagation timing of the read control signal nRE based on a propagation delay between the selected flash memory unit (2) 140 and controller 110, and based on a setup time with respect to a system clock signal of the read data.

The controller 110 may receive read data appearing in the common input/output bus 160 when a system clock is at a rising edge. When the read data normally appears in the common input/output bus 160 ahead of the time when the system clock is at the rising edge, the controller 110 receives the read data without an error. The time when the read data normally appears in the common input/output bus 160 before the system clock is at the rising edge is referred to as a setup time. The controller 110 may adjust the propagation timing of the read control signal nRE to obtain a sufficient setup time. Since the setup time is affected by the propagation delay between the selected flash memory unit (2) 140 and controller 110, the controller 110 may adjust the propagation timing of the read control signal nRE based on the propagation delay and setup time.

The controller 110 checks whether an error exist in the read data and changes the propagation timing of the read control signal when the error exists, and thereby can adjust the propagation timing.

Examples of a method for an error check in the read data include an error check after decoding error control codes (ECC), an integrity check of a parity bit, and the like.

According to another example embodiment of the present invention, a flash memory device (not illustrated) may adjust a timing with respect to each channel, bank, and flash memory chip every time the flash memory device performs device diagnostics. Examples of the device diagnostics performing an adjustment of the timing includes a power-on restart, soft restart, device diagnostic command execution, and the like.

A controller of the flash memory (not illustrated) may adjust a propagation timing of a read control signal nRE based on a propagation delay between a memory unit and the controller.

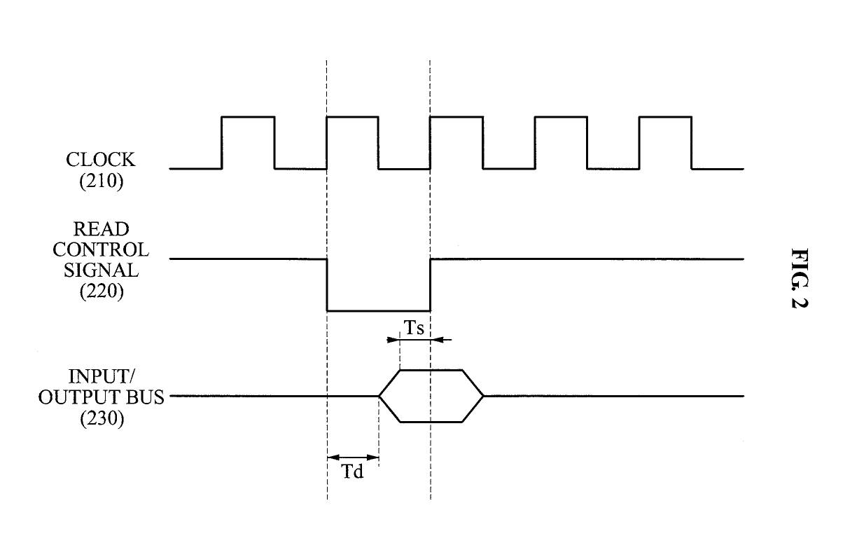

FIG. 2 illustrates an example of a flash memory read control method performed by the flash memory device 100.

Referring to FIG. 2, the controller 110 propagates a system clock 210 to each of the flash memory units (0, 1, 2, and 3) 120, 130, 140, and 150.

The controller 110 propagates a read control signal nRE 220 one clock ahead of a target rising edge of a system clock 210, the target rising edge being a time when the controller desires to receive read data.

In this instance, it is assumed that a flash memory unit (0) 120 is selected.

The controller 110 may adjust a propagation timing of the read control signal nRE 220 based on a fact that a propagation delay between the selected flash memory unit (0) 120 and controller 110 is short. The controller 110 propagates the read control signal nRE 220 to the selected flash memory unit (0) 120 according to adjusted propagation timing of the read control signal nRE 220.

The selected flash memory unit (0) 120 may propagate read data to a common input/output bus 160 Td time after receiving the read control signal nRE 220. A waveform 230 represents a signal appearing in the common input/output bus 160. According to the waveform 230, the read data normally appears in the common input/output bus 160 Ts time before the target rising edge of the system clock 210.

The controller 110 may receive the read data from the common input/output bus 160 at the target rising edge of the system clock 210. In this instance, the Ts time is a setup time with respect to the system clock of the read data, which is a sufficiently long time, and thus the controller 110 may receive the read data from the selected flash memory unit (0) 120 without an error.

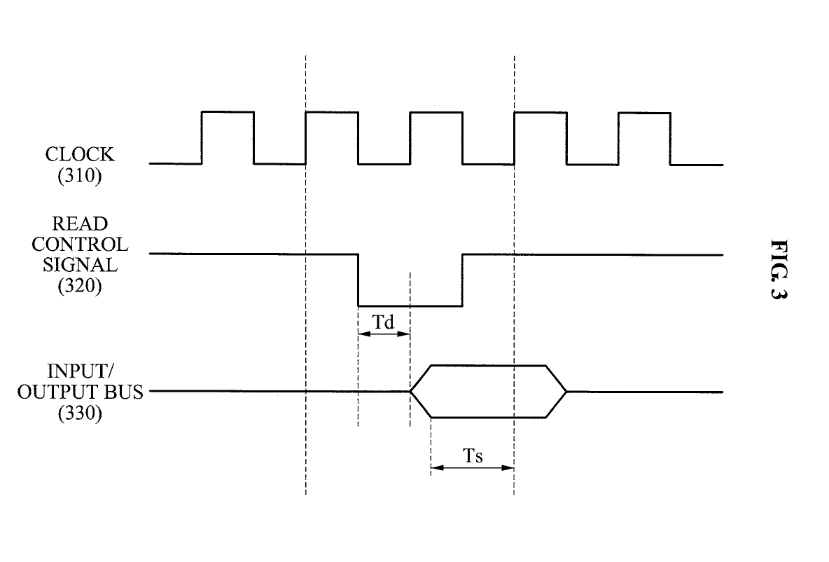

FIG. 3 illustrates another example of a flash memory read control method performed by the flash memory device 100.

Referring to FIG. 3, the controller 110 propagates a system clock 310 to each of the flash memory units (0, 1, 2, and 3) 120, 130, 140, and 150.

A controller 110 propagates a read control signal nRE 320 3/2 clock ahead of a target rising edge timing of the system clock 310, the target rising edge timing being a time when the controller desires to receive read data.

In this instance, it is assumed that a flash memory unit (2) 140 is selected.

The controller 110 may adjust a propagating timing of the read control signal nRE 320 based on a propagation delay between the selected flash memory unit (2) 140 and controller 110.

The controller 110 may propagate the read control signal nRE 320 to the selected flash memory unit (2) 140 according to the adjusted propagation timing of the read control signal nRE 320.

Since the propagation delay between the selected flash memory unit (2) 140 and the controller 110 is longer than a propagation delay between the flash memory unit (0) 120 and the controller 110, and a sufficient setup time may not be obtained through the read control method of FIG. 2, the controller 110 may select a propagation timing of the read control signal nRE 320 that is slower than the propagation timing of FIG. 2.

In this instance, the controller 110 may set a timing of 3/2 clocks after propagating the read control signal nRE 320 as the target rising edge, and may receive the read data from the common input/output bus 160 at the target rising edge.

The selected flash memory unit (2) 140 may propagate the read data to the common input/output bus 160 Td time after receiving the read control signal nRE 320. A waveform 330 represents a signal appearing in the common input/output bus 160. According to the waveform 330, the read data normally appears in the common input/output bus 160 Ts time before the target rising edge of the system clock 310.

The controller 110 may receive the read data from the common input/output bus 160 at the target rising edge of the system clock 310. In this instance, the Ts time is a setup time with respect to the system clock 310 of the read data, which is a sufficiently long time, and thus the controller 110 may receive the read data from the selected flash memory unit (2) 140 without an error.

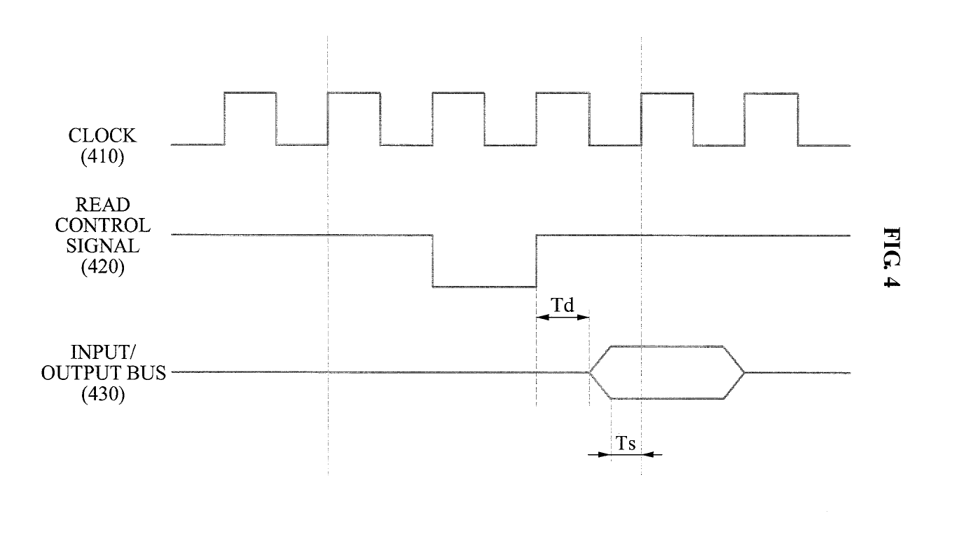

FIG. 4 illustrates still another example of a flash memory read control method performed by the flash memory device 100.

Referring to FIG. 4, the controller 110 propagates a system clock 410 to each of flash memory units (0, 1, 2, and 3) 120, 130, 140, and 150.

The controller 110 propagates a read control signal nRE 420 two clocks ahead of a target rising edge timing of the system clock 410.

In this instance, it is assumed that the flash memory unit (3) 150 is selected.

The controller 110 adjusts a propagation timing of the read control signal nRE 420 based on a fact that a propagation delay between the selected flash memory unit (3) 150 and controller 110 is extremely long. The controller 110 may propagate the read control signal nRE 420 to the selected flash memory unit (3) 150 according to the adjusted propagation timing of the read control signal nRE 420.

Since a propagation delay between the selected flash memory unit (3) 150 and the controller 110 is longer than a propagation delay between the flash memory unit (2) 140 and the controller 110, and a sufficient setup time may not be obtained through the read control method of FIG. 3, the controller 110 may select a propagation timing of the read control signal nRE 420 that is later than the propagation timing of FIG. 3.

In this instance, the controller 110 may set a timing of two clocks after propagating the read control signal nRE 420 as the target rising edge, and may receive the read data from the common input/output bus 160 at the target rising edge.

The selected flash memory unit (3) 150 may propagate the read data to the common input/output bus 160 Td time after receiving the read control signal nRE 420. A waveform 430 represents a signal appearing in the common input/output bus 160. According to the waveform 430, the read data normally appears in the common input/output bus 160 Ts time before the target rising edge of the system clock 410.

The controller 110 may receive the read data from the common input/output bus 160 at the target rising edge of the system clock 410. In this instance, the Ts time is a setup time with respect to the system clock 410 of the read data, which is a sufficiently long time, and thus the controller 110 may receive the read data from the selected flash memory unit (3) 150 without an error.

Referring to FIGS. 1 to 4 again, the controller 110 may adjust a timing of a read control signal optimized for flash memory units (0, 1, 2, and 3) 120, 130, 140, and 150.

Since a propagation delay between the controller 110 and the flash memory unit (0) 120 is short, the controller 110 may propagate the read control signal at an earlier time with respect to the flash memory unit (0) 120, thereby receiving read data at an earlier time.

Since a propagation delay between the controller 110 and the flash memory unit (3) 150 is long, the controller 110 may propagate the read control signal at a later time with respect to the flash memory unit (3) 150, thereby receiving read data at a later time.

According to another example embodiment of the present invention, a flash memory device (not illustrated) may be applicable to a flash memory system wherein a plurality of flash memory units are connected. The flash memory device may provide a propagation timing of a read control signal optimized for each of the flash memory units. The flash memory device may adjust the propagation timing of the read control signal to receive read data from each of the flash memory units with a shortest delay time and without an error. According to the method, the flash memory device may enable a fast system clock to be used and may obtain a high data throughput in the flash memory system where the plurality of flash memory units are connected.

Although flash memory units (0, 1, 2, and 3) 120, 130, 140, and 150 sharing the one common input/output bus 160 and the controller 110 are illustrated, the flash memory read control method of the present invention is not limited to when the flash memory units share the common input/output bus, and is applicable to when the flash memory units respectively propagate and receive data via a separate input/output bus.

Depending on example embodiments, a flash memory channel, flash memory bank, and flash memory chip may be practical as an element denoted as a flash memory unit throughout the present specification, and the fact is apparent to those skilled in the art.

According to another example embodiment of the present invention, a flash memory device (not illustrated) may store a predetermined specific bit pattern (hereinafter, test pattern) in a flash memory unit.

A controller propagates a read control signal with respect to the test pattern to the flash memory unit, and receives the stored test pattern from the flash memory unit.

When read data does not have sufficient setup time since a propagation delay between the controller and flash memory unit is long, the test pattern that the controller receives may be different from the predetermined test pattern.

In this instance, the controller compares the received test pattern with the predetermined test pattern, and detects an error in the received test pattern. When the error is detected, the controller may delay a propagation timing of the read control signal and receive the storedtest pattern again from the flash memory unit.

The controller may search for the earliest propagation timing in a range of where an error of the received test pattern is not detected, and may determine a retrieval propagation timing as an optimized propagation timing.

The example embodiment includes an operation of storing a test pattern in a flash memory unit. However, according to another example embodiment, the test pattern may be stored in a predetermined address when the flash memory unit is manufactured. According to the other example embodiment, an operation of searching for an optimized propagation timing using the test pattern may be the same.

The flash memory device of the present invention may search for a propagation timing of a read control signal for each channel, and a system may perform a read operation according to an optimized propagation timing retrieved for each channel.

Also, the flash memory device of the present invention may search for the propagation timing of the read control signal for each bank in each channel, and the system may perform the read operation according to the optimized propagation timing retrieved for each bank.

Also, the flash memory device of the present invention may search for the propagation timing of the read control signal for each chip of each bank in each channel, and the system may perform the read operation according to optimized propagation timing retrieved for each chip.

The flash memory device of the present invention may search for the propagation timing of the read control signal during a power-on restart operation and soft restart operation. Also, the flash memory device of the present invention may search for the propagation timing of the read control signal during device diagnostics.

Also, the flash memory device of the present invention may search for the propagation timing of the read control signal when a read operation error occurs. Also, the flash memory device of the present invention may periodically search for the propagation timing of the read control signal.

Also, the flash memory device of the present invention may search for the propagation timing of the read control signal in a certain time when an explicit request from an operation system or user exists.

The propagation delay may be determined based on characteristics of each flash memory unit setduring the manufacturing operation, based on an arrangement of each flash memory unit, and based on an environment, such as a temperature, and the like.

Since a conventional read control method uses a fixed propagation timing, although an error occurs only in a single flash memory unit, all flash memory units are determined as being defective. However, the flash memory device of the present invention provides a propagation timing optimized for each flash memory device, thereby dramatically increasing an yield of the flash memory system.

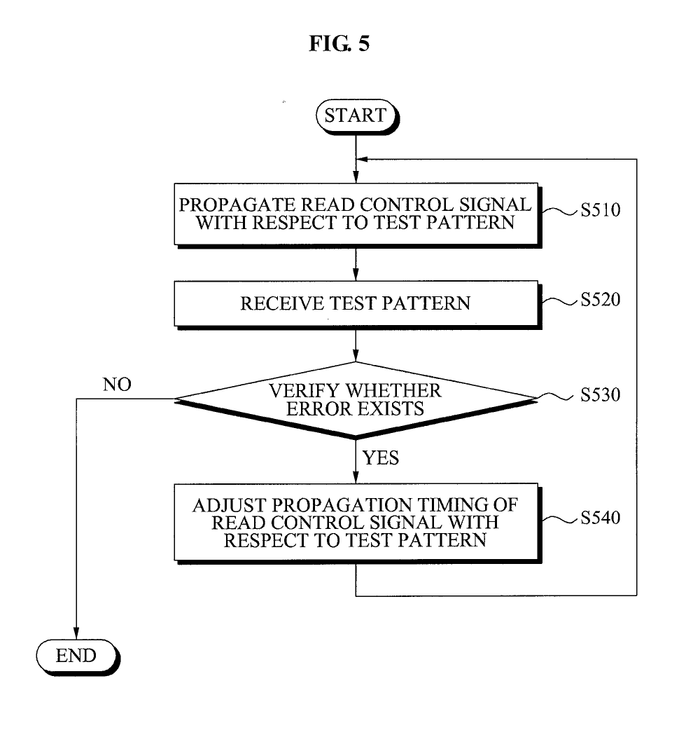

FIG. 5 is a flowchart illustrating a flash memory read control method according to example embodiment of the present invention.

Referring to FIG. 5, the read control method propagates a read control signal with respect to a test pattern to a flash memory unit in operation 5510.

The read control method receives the test pattern from the flash memory units in operation 5520.

The read control method verifies whether an error with respect to the received test pattern exists in operation 5530.

When the error with respect to the received test pattern exists, the read control method adjusts a propagation timing of a read control signal with respect to the test pattern in operation 5540.

The read control method may complete the read control method when the error with respect to the test pattern does not exist.

When the error with respect to the received test pattern does not exist, the read control method may propagate a read control signal with respect to data to the flash memory unit using a present propagation timing. In this instance, the read control method may receive read data corresponding to the read control signal from the flash memory unit.

The read control method performs operation S510 again after performing operation S540.

The read control method iteratively performs operations S510 to S540, thereby propagating the read control signal with respect to the data to the flash memory unit according to a finally determined propagation timing.

The flash memory read control method according to example embodiments may be recorded in computer-readable media including program instructions to implement various operations embodied by a computer. The media may also include, alone or in combination with the program instructions, data files, data structures, and the like. The media and program instructions may be those specially designed and constructed for the purposes of example embodiments, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of example embodiments.

Flash memory devices and/or memory controllers according to example embodiments may be embodied using various types of packages. For example, the flash memory devices and/or memory controllers may be embodied using packages such as Package on Packages (PoPs), Ball Grid Arrays (BGAs), Chip Scale Packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Quad Flatpack (QFP), Small Outline Integrated Circuit (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), and the like.

The flash memory devices and/or the memory controllers may constitute memory cards. In this case, the memory controllers may be constructed to communicate with an external device for example, a host using any one of various types of protocols such as a Universal Serial Bus (USB), a Multi Media Card (MMC), a Peripheral Component Interconnect-Express (PCI-E), Serial Advanced Technology Attachment (SATA), Parallel ATA (PATA), Small Computer System Interface (SCSI), Enhanced Small Device Interface (ESDI), and Integrated Drive Electronics (IDE).

The flash memory devices may be non-volatile memory devices that can maintain stored data even when power is cut off According to an increase in the use of mobile devices such as a cellular phone, a personal digital assistant (PDA), a digital camera, a portable game console, and an MP3 player, the flash memory devices may be more widely used as data storage and code storage. The flash memory devices may be used in home applications such as a high definition television (HDTV), a digital video disk (DVD), a router, and a Global Positioning System (GPS).

A computing system according to example embodiments may include a microprocessor that is electrically connected with a bus, a user interface, a modem such as a baseband chipset, a memory controller, and a flash memory device. The flash memory device may store N-bit data via the memory controller. The N-bit data is processed or will be processed by the microprocessor and N may be 1 or an integer greater than 1. When the computing system is a mobile apparatus, a battery may be additionally provided to supply operation voltage of the computing system.

It will be apparent to those of ordinary skill in the art that the computing system according to example embodiments may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

Although a few example embodiments of the present invention have been shown and described, the present invention is not limited to the described example embodiments. Instead, it would be appreciated by those skilled in the art that changes may be made to these example embodiments without departing from the principles and spirit of the invention, the scope of which is defined by the claims and their equivalents.

1. A flash memory device, comprising:
a plurality of flash memory units;
a common input/output bus connected with each of the plurality of flash memory units; and
a controller to propagate a read control signal to a flash memory unit selected from among the plurality of flash memories and to receive data read from the selected flash memory unit via the common input/output bus, the controller being connected with the common input/output bus,
wherein the controller adjusts a propagation timing of the read control signal unit based on a propagation delay corresponding to the selected flash memory unit.

2. The flash memory of claim 1, wherein the controller respectively adjusts the propagation timing of the read control signal with respect to each of the plurality of flash memory units.

3. The flash memory of claim 1, wherein the selected flash memory unit propagates the read data to the controller via the common input/output bus a predetermined time after receiving the read control signal.

4. The flash memory of claim 1, wherein the controller propagates a clock signal to each of the plurality of flash memory units and adjusts the propagation timing of the read control signal based on the propagation delay corresponding to the selected flash memory unit and based on a setup time with respect to the clock signal of the read data.

5. A flash memory device, comprising:
a flash memory unit; and
a controller to propagate a read control signal to the flash memory unit and to receive data read from the flash memory unit via a data route,
wherein the controller adjusts a propagation timing of the read control signal based on a propagation delay corresponding to the flash memory unit.

6. The flash memory device of claim 5, wherein the flash memory unit propagates the read data to the controller via the data route a predetermined time after receiving the read control signal.

7. The flash memory device of claim 5, wherein the controller adjusts propagation timing of the read control signal based on the propagation delay corresponding to the flash memory unit and based on whether an error exists in the read data.

8. The flash memory device of claim 5, wherein the controller propagates a clock signal to the flash memory unit and adjusts the propagation timing of the read control signal based on the propagation delay corresponding to the flash memory unit and based on a setup time with respect to the clock signal of the read data.

9. A flash memory device, comprising:
a flash memory unit storing a test pattern; and
a controller to propagate a read control signal with respect to the test pattern to the flash memory unit and to receive the stored test pattern from the flash memory unit,
wherein the controller detects whether an error exists in the received test pattern to search for an optimized read control timing and adjusts a propagation timing of the read control signal with respect to the flash memory unit based on the retrieved read control timing.

10. The flash memory device of claim 9, wherein the controller propagates the read control signal to the flash memory unit according to the adjusted propagation timing, and the flash memory unit propagates read data to the controller a predetermined time after receiving the read control signal.

11. The flash memory device of claim 9, wherein the controller propagates the read control signal with respect to the test pattern when the flash memory device is in any one of a restart sequence based on power connection after disconnection, a restart sequence based on software, or a device diagnostic mode.

12. A read control method of a flash memory device, the method comprising:
propagating a read control signal with respect to a test pattern to a flash memory unit;
receiving the test pattern from the flash memory unit;
verifying whether an error exists in the received test pattern; and
adjusting a propagation timing of the read control signal with respect to the test pattern according to a result of the verifying.

13. The method of claim 12, further comprising:
re-propagating the read control signal with respect to the test pattern to the flash memory unit according to the adjusted propagation timing, when an error exists as the result of the verifying.

14. The method of claim 12, further comprising:
propagating a read control signal with respect to data to the flash memory unit according to the adjusted propagation timing; and
receiving read data corresponding to the read control signal with respect to the data from the flash memory unit.

15. A computer readable recording device storing a program for implementing a read control method of a flash memory device, the method comprising:
propagating a read control signal with respect to a test pattern to a flash memory unit;
receiving the test pattern from the flash memory unit;
verifying whether an error exists in the received test pattern; and
adjusting a propagation timing of the read control signal with respect to the test pattern according to a result of the verifying.

16. The computer readable recording device of claim 15, wherein the method further comprises:
re-propagating the read control signal with respect to the test pattern to the flash memory unit according to the adjusted propagation timing, when an error exists as the result of the verifying.

17. The computer readable recording device of claim 15, wherein the method further comprises:
propagating a read control signal with respect to data to the flash memory unit according to the adjusted propagation timing; and
receiving read data corresponding to the read control signal with respect to the data from the flash memory unit.
